(19) United States
(12) Patent Application Publication
(10) Pub. No.: US 2026/0287740 A1
(43) Pub. Date: Sep. 24, 2026

(54) Automatic Radar Range Control

(71) Applicant: TOCARO BLUE, INC., Pensacola, FL (US)

(72) Inventor: Austin Gurley, Birmingham, AL (US)

(21) Appl. No.: 19/572,687

(22) Filed: Mar. 19, 2026

Related U.S. Application Data
(60) Provisional application No. 63/775,961, filed on Mar. 21, 2025.

(51) Int. Cl. G01S 13/937; G01S 7/04; G01S 7/40; G01S 13/00; G01S 13/86; G01S 13/89

(52) U.S. Cl. CPC G01S 13/937; G01S 7/043; G01S 7/4004; G01S 13/006; G01S 13/86; G01S 13/89

(57) ABSTRACT

A radar system may include a radar antenna and a radar controller. The radar controller may be configured to determine a surrounding land boundary map for a vessel based on shoreline data and generate a land distance data array based on radar ray information for a plurality of radar rays provided by the radar antenna under the control of the radar controller. The radar controller may also be configured to determine a statistical distance measurement to land based on the land distance data array, determine a land overlap of a current radar range setting and scale the statistical distance measurement based on the land overlap to determine a scaled statistical distance measurement, and automatically adjust the radar range from the current radar range setting based on the scaled statistical distance measurement.

### CROSS-REFERENCE TO RELATED APPLICATION(S)

The present application claims priority to U.S. Provisional Patent Application Ser. No. 63/775,961 filed on Mar. 21, 2025, the content of which is hereby incorporated by reference.

### TECHNOLOGICAL FIELD

The present disclosure relates generally to marine radar technology. More specifically, example embodiments relate to methods and systems for automatically controlling the range of a marine radar based on environmental and operational parameters.

### BACKGROUND

Radar systems have become commonplace on many marine vessels of a certain size, and such systems have proven to be useful for detecting other objects on the water that are in the surrounding area of the vessel. The radar information provided to a pilot or operator of a vessel can be extremely helpful for navigation at sea, particularly in low visibility conditions.

The raw information, or radar data, provided by a radar system can be plotted on a display screen to present the radar data to the operator. However, there is a need for improvements in radar technology. Radar range control is largely a manual operation that involves user experience to implement a useful range setting for a radar system. It would therefore be desirable to have a system and method that implements improvements in this area of radar operation.

### BRIEF SUMMARY

According to some example embodiments, a radar system is provided. The radar system may comprise a radar antenna and a radar controller. The radar controller may be configured to determine a surrounding land boundary map for a vessel based on shoreline data and generate a land distance data array based on radar ray information for a plurality of radar rays provided by the radar antenna under the control of the radar controller. The radar ray information may comprise, for each radar ray in a plurality of radar rays, an angle the ray from the vessel, a range of the ray to a first land hit, and first land hit coordinate information. The radar controller may also be configured to determine a statistical distance measurement to land based on the land distance data array, determine a land overlap of a current radar range setting and scale the statistical distance measurement based on the land overlap to determine a scaled statistical distance measurement, and automatically adjust a radar range setting from the current radar range setting based on the scaled statistical distance measurement.

According to some example embodiments, a radar controller is provided. The radar controller may comprise a processor and a memory storing instructions that, when executed by the processor, configure the radar controller to perform various operations. In this regard, the radar controller may be configured to determine a surrounding land boundary map for a vessel based on shoreline data and generate a land distance data array based on radar ray information for a plurality of radar rays provided by the radar antenna under the control of the radar controller. The radar ray information may comprise, for each radar ray in a plurality of radar rays, an angle the ray from the vessel, a range of the ray to a first land hit, and first land hit coordinate information. The radar controller may also be configured to determine a statistical distance measurement to land based on the land distance data array, determine a land overlap of a current radar range setting and scale the statistical distance measurement based on the land overlap to determine a scaled statistical distance measurement, and automatically adjust a radar range setting from the current radar range setting based on the scaled statistical distance measurement.

According to some example embodiments, a method for automatically setting a range for a radar system is provided. In this regard, the method may comprise determining a surrounding land boundary map for a vessel based on shoreline data and generating, by a radar controller, a land distance data array based on radar ray information for a plurality of radar rays provided by the radar antenna under the control of the radar controller. The radar ray information may comprise, for each radar ray in a plurality of radar rays, an angle the ray from the vessel, a range of the ray to a first land hit, and first land hit coordinate information. The method may also comprise determining a statistical distance measurement to land based on the land distance data array, determining a land overlap of a current radar range setting and scale the statistical distance measurement based on the land overlap to determine a scaled statistical distance measurement, and automatically adjusting a radar range setting from the current radar range setting based on the scaled statistical distance measurement.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a rendering associated with an automatic radar range control process according to some example embodiments;

FIG. 2A illustrates a rendering associated with determining a surrounding land boundary map according to some example embodiments;

FIG. 2B illustrates a rendering associated with outputting radar rays to determine land hits according to some example embodiments;

FIG. 2C illustrates a rendering associated with adjusting a radar range setting according to some example embodiments;

FIG. 2D illustrates a rendering associated with adjusting a radar range setting within a canal or cove according to some example embodiments;

FIG. 2E illustrates a rendering associated with adjusting a radar range setting exiting a canal or cove according to some example embodiments;

FIG. 3 illustrates a rendering associated with radar data and map data alignment for compass calibration according to some example embodiments;

FIG. 4 illustrates a block diagram of a system and apparatus for implementing automatic radar range control according to some example embodiments; and

FIG. 5 illustrates a flowchart of a method for implementing automatic radar range control according to some example embodiments.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

According to some example embodiments, systems, apparatuses, and methods are described herein that implement automatic radar range control in the context of marine radar systems. In this regard, according to some example embodiments, an analysis of the surrounding shoreline to a marine vessel may be performed and, based upon a determined statistical distance measurement of the surrounding shoreline relative to the vessel. In general, an approach according to some example embodiments involves determining a marine radar range that is not too small so as not to reach nearby targets of interest (e.g., other vessels that should be tracked for potential movement interference) but not too large that such targets of interest are difficult to distinguish due to blending and cluttering landmass features and objects.

To perform automatic radar range control, according to some example embodiments, a variety of objectives and parameters may be considered. One objective may be to detect targets at maximum possible distance without introducing excessive clutter. Additionally, when a vessel is moving, the speed or rate of the radar sweep may be a factor relative to the velocity of the vessel. In this regard, a relationship and threshold for vessel velocity relative to a percentage of the radar range radius per sweep may be defined. Such factors and others may be considered in combination with maintaining sufficient resolution to properly visualize targets and other objects. To do so, according to some example embodiments, an approach may operate to consider the shoreline, but also limit or minimize overlap with landmass features to avoid unnecessary clutter and noise.

Accordingly, example embodiments described herein may perform automatic radar range control based on a plurality of considerations. A first consideration may involve maintaining a consistent statistical measure of distance-to-land. A second consideration may involve increasing the radar range when vessel speed exceeds a predetermined threshold. Such example embodiments may comprise a radar system having a radar antenna and a radar controller. The radar controller may be configured to automatically adjust radar range based on statistical distance measurements to land boundaries. The radar controller may further be configured to consider vessel speed and targets of interest when determining appropriate range settings. Additionally, landmass maps may be leveraged for implementing automatic radar range control. Such maps may include shoreline data in conjunction with global positioning system (GPS) positioning. Direct radar detection of bulk landmasses may also be leveraged in accordance with some example embodiments. In this regard, landmass detection may be accomplished using, for example, a semantic segmentation model.

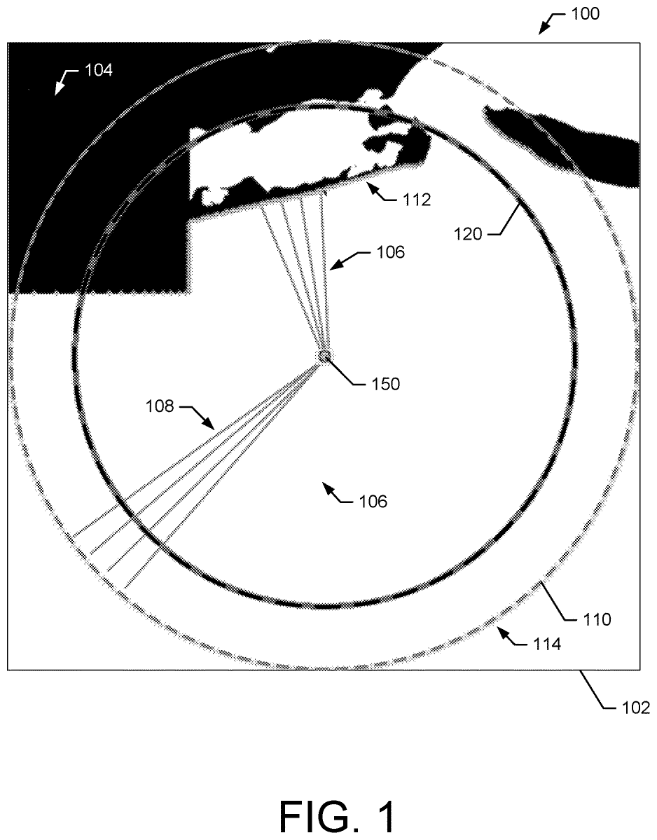

Now referring to FIG. 1, an example implementation of an automatic radar range control process is shown with respect to rendering 100. Relative to the vessel 150 a surrounding land boundary map 102 around the vessel 150 is defined. Although, the surrounding land boundary map 102 is shown as having a rectangular shape in rendering 100, it is understood that the surrounding land boundary map 102 may take any shape, including non-uniform shapes. The surrounding land boundary map 102 may include land portions 104 and water portions 106. A radar system on the vessel 150 may, during a radar sweep using a current radar range 110, output radar rays 106 that hit a landmass and radar rays 108 that do not hit a landmass. Accordingly, the radar rays may result in landmass hits 112 or non-landmass hits 114. Radar information associated with the landmass hits 112 from the radar rays may be stored in a land distance data array. The data array may be processed to generate a statistical distance measurement that may then be scaled based on the degree of land overlap within the current radar range. Based on the scaled statistical distance, the radar range may be automatically adjusted (e.g., to have a smaller radius) to a radar range 120. Due to the adjustment, the new radar range 120 includes nearby shoreline, but also eliminates at least some portion of the landmass to eliminate as least some land-based clutter and noise.

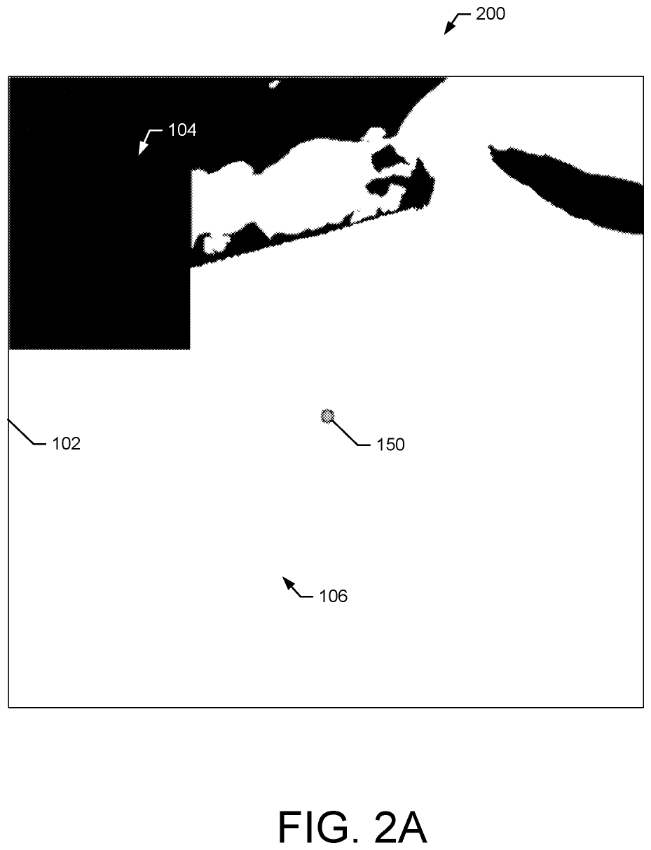

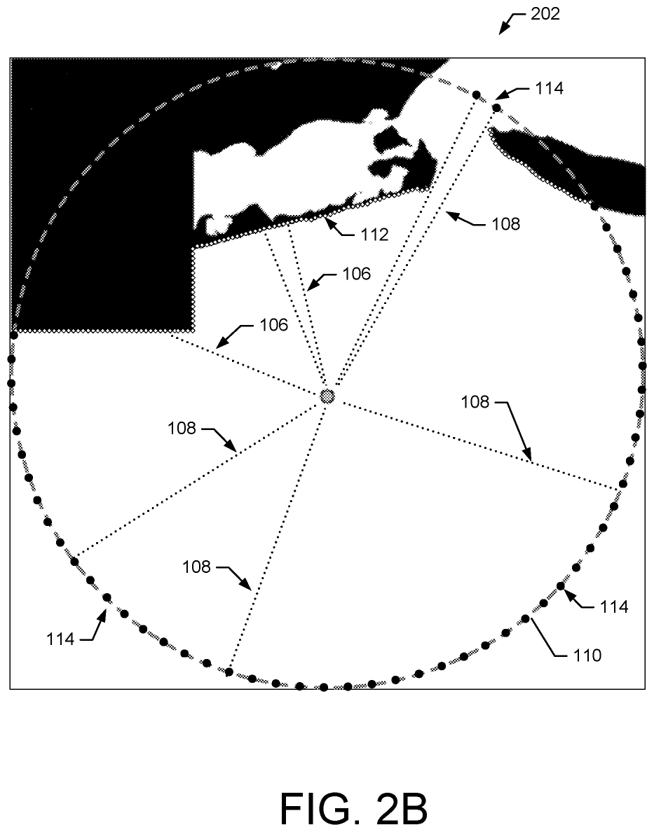

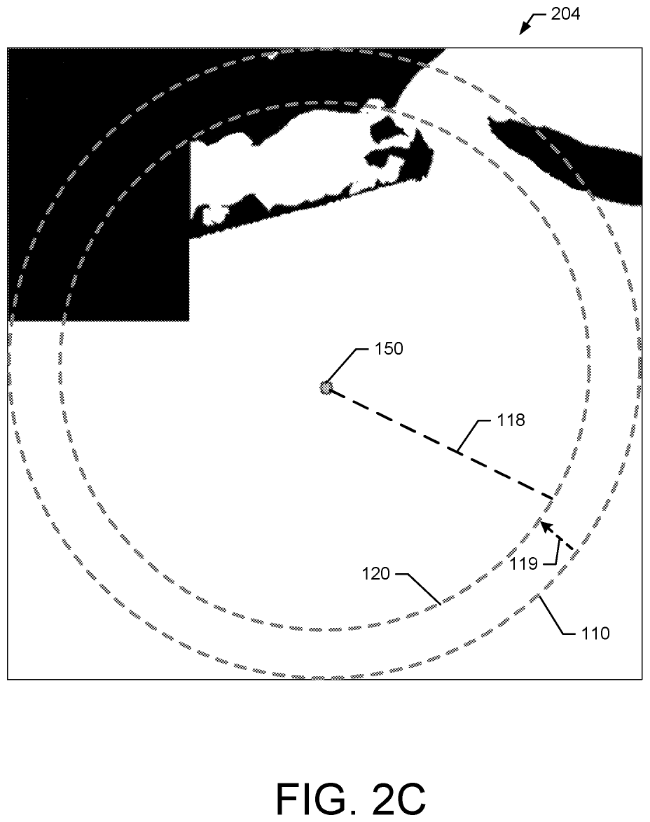

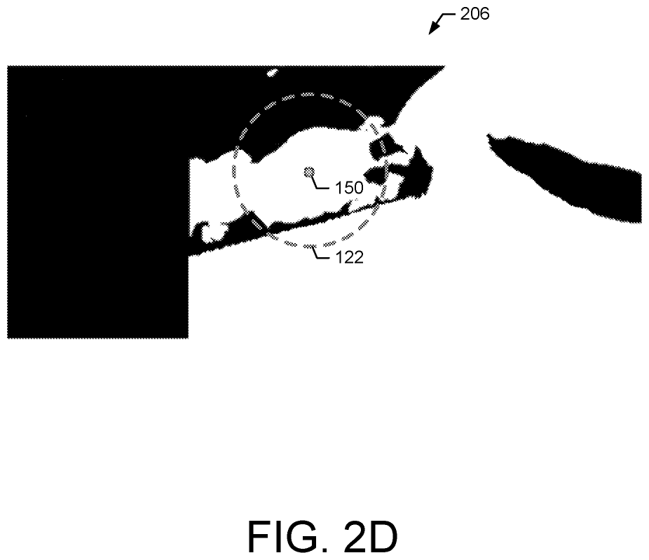

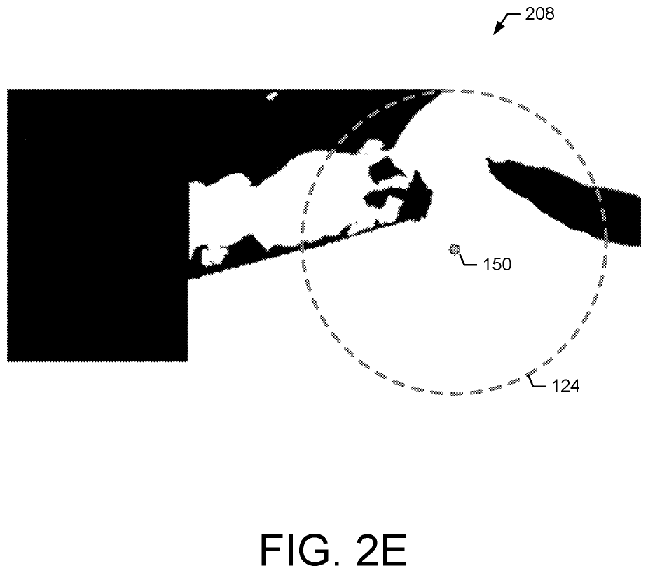

Having provided a condensed description an example automatic radar range control process with respect to the rendering 100 of FIG. 1, a more detailed explanation of various example embodiments with respect to FIGS. 2A to 2C will now be provided. Again, automatic radar range control may be performed based on a distance to land, according to some example embodiments. In this regard, some example embodiment may measure distance to land in multiple directions relative to the vessel and a synthesis of the distances may be performed to assist with automatic radar range control.

With reference to FIG. 2A and the rendering 200, the surrounding land boundary map 102 may be determined, for example by a radar controller, for a vessel 150 based on shoreline data. The surrounding land boundary map 102 may be defined with respect to the position of the vessel 150, which includes the radar system comprising the radar antenna and the radar controller. The surrounding land boundary map 102 may, according to some example embodiments, be defined or generated around the current position of the vessel 150.

In this regard, according to some example embodiments, the surrounding land boundary map 120 may be created based on shoreline data that may be obtained from a variety of sources. According to some example embodiments, the surrounding land boundary map 102 may be defined based on a GPS location of the vessel 150, an electronic compass reading for orienting, and pre-existing map data. According to some example embodiments, shoreline vector data may be used and combined with the GPS location of the vessel 150 to generate the surrounding land boundary map 102. Moreover, the surrounding land boundary map 102 may take the form of a raster image of the land area surrounding the vessel 150. Alternatively, the surrounding land boundary map 102 may be created by determining land boundaries directly from radar imagery and hits from radar returns that indicate the presence of a landmass.

According to some example embodiments, a land boundary determination for the surrounding land boundary map 102 may be determined from radar imagery using, for example, a contour size analysis. In this regard, large contours (e.g., contours that are more than a minimum size or having a minimum edge length (for example, 500 meters)) may be assumed to represent land features. According to some example embodiments, land classification may alternatively be performed using a machine learning model that has been trained to identify patterns in radar imagery data that are indicative of a shoreline of a landmass. Additionally or alternatively, a machine vision model may also be employed for land classification, which may involve capturing and analyzing video images to determine the presence of a landmass based on a vision model. In some example embodiments, to simplify the analysis, all radar returns, regardless of their contribution to a contour, may be assumed, on average, to represent land objects.

According to some example embodiments, the surrounding land boundary map 102 may be defined, when using pre-existing map data, to have a dimension (e.g., width, diameter, etc.) that may be twice a maximum desired automatic range. When using radar imagery alone, the surrounding land boundary map 102 may be defined to extend to the edges of the current radar range. Moreover, pixel resolution may be a small fraction of the steps between viable radar range settings. Further, in example embodiments that rely upon radar imagery without a pre-existing map, determining an optimal range may involve an iterative process when increasing the range. However, reducing the range may be performed in a single implementation, since the necessary data may have been captured due to the current radar range setting.

Now referencing FIG. 2B, a ray-based distance measuring process may be implemented, according to some example embodiments. Such ray-based distance measuring process may be performed by a radar controller and may involve generating a land distance data array based on radar ray information for a plurality of radar rays provided by a radar antenna under the control of the radar controller. The radar ray information may comprise, for each radar ray in a plurality of radar rays, an angle the ray from the vessel, a range of the ray to a first land hit, and first land hit coordinate information.

In this regard, some example embodiments may control a radar antenna to output multiple rays extending outward from the antenna and the position of the vessel 150 at a range 110. The number of rays may range from, for example, 36 to 360 rays as the radar antenna sweeps. Other numbers of rays may be employed depending on the desired resolution and computational resources. For each ray, a distance from the vessel 150 to the first intersection with an object such as land may be determined. This information may be stored in a land distance array. The land distance array may include, for each ray, an angle from the vessel 150. The array may further include a range to the first land hit for the respective ray. The array may also include an x-location and a y-location (or other coordinate system values) of the first land hit for the respective ray, where, for example, the vessel 150 is positioned at an origin and the x-axis may be east-west and the y-axis may be north-south. In cases where the radar range extends beyond the surrounding land boundary map 102 or a maximum desired range setting, the point intersecting a circle of the maximum range radius may be saved and may indicate that no return signal was received for that respective ray.

As can be seen in rending 202 of FIG. 2B, example radar rays are shown emanating from the vessel 150. Although only a few rays are shown, it is understood that rays would be output in a pattern in association with the sweeping motion of the radar antenna. In the rendering 202, the rays 106 have returns indicative of land-based hits 112. As such, for each land hit for a given ray, the angle, distance, and coordinates may be stored in the land distance data array. Additionally, the rays 108 have no returns indicating that no object is present, resulting full range hits 114. As such, according to some example embodiments, for each full range hit 114, the angle, distance (a maximum range distance based on the current radar range setting), and coordinates may be stored in the land distance data array. According to some example embodiments, the storage of the range maximum distance for a given radar ray may indicate that no return was received. According to some example embodiments, a flag or other indicator may be used in the data array to indicate that no radar return was received.

Having generated the land distance data array, an analysis of the data of the array may be performed by the radar controller to determined a statistical distance measurement for the land distance data array. According to some example embodiments, various reduction methods may be employed to compute the statistical distance measurement. In some example embodiments, the distances of the full range hits 114 need not be considered or may be weighted less in the analysis.

According to some example embodiments, the statistical distance measurement may comprise a median distance value of the ray entries within the data array. In another example embodiment, the statistical distance measurement may comprise the average distance value. In yet another example embodiment, the statistical distance measurement may comprise the average distance after removal of outlier values that are indicative of noise or do not satisfy a filter. In a further example embodiment, the statistical distance measurement may comprise a weighted sum of principal component analysis (PCA) components of the coordinates of the hits.

Additionally, a scaling operation may be performed to determine a scaled statistical distance measurement. According to some example embodiments, the radar controller may determine a land overlap of a current radar range setting and scale the statistical distance measurement based on the land overlap to determine a scaled statistical distance measurement. Moreover, in some example embodiments, the statistical distance measurement may be scaled based on the overlap of the current radar range with land. A scaling factor from 1.0 to 1.5 may provide satisfactory results. The scaling factor may be determined based on, for example, a percentage of the area within the current radar range setting that is determined to be land. In this regard, for example, if less than a threshold percentage of land area is within range, then the statistical distance measurement may be scaled upwards based on a delta between the percentage of land and the threshold. Additionally, according to some example embodiments, other scaling factors may be employed depending on operational requirements.

Having determined the scaled statistical distance measurement, the radar controller may be configured to automatically adjust a radar range setting from the current radar range setting based on the scaled statistical distance measurement. In this regard, the radar range setting may be adjusted to be the scaled statistical distance measurement or to a radar range setting that is closest to the scaled statistical distance measurement. For example, the radar range setting may be set to an available value near the scaled statistical distance measurement. The selected value may be the nearest available range setting. Alternatively, the selected value may be the next highest available range setting. In other embodiments, the selected value may be the next lowest available range setting.

As shown in the rendering 204 of FIG. 2C, the scaled statistical distance measurement 118 has been determined. As such, the current radar range 110 is adjusted by a distance 119 to be new radar range setting 120. Thereafter, according to some example embodiments, the autoranging process may begin anew with the current radar range setting being the radar range setting 120.

Accordingly, dependent on the location of the vessel 150 relative to land areas, the radar range setting may adjust accordingly via implementation of the automatic radar range control process according to some example embodiments. In an example as shown in the rendering 206 of FIG. 2D, the vessel 150 is now located within a cove area where land is adjacent on more than one side of the vessel 150. As such, to limit the impact of land-based objects, the resulting radar range setting 122 is relatively low (considering the radar range setting 120 when the vessel 150 is further offshore). Similarly, in an example as shown in the rendering 208 of FIG. 2E, the vessel 150 is now located in an area at the exit of a canal or cove area, but not yet in open water. As such, to limit the impact of land-based objects, the resulting radar range setting 124 is higher than the canal/cove setting shown in FIG. 2D, but still smaller than the radar range setting 120 when the vessel 150 is further offshore.

According to some example embodiments, automatic radar range control may be performed in accordance with different operational modes based on the location of the vessel relative to landmasses. In this regard, different operational modes may be associated with different scaling approaches for the scaling the statistical distance measurement. For example, a in harbor operational mode, minimal or no scaling may be employed, thereby maintain the radar range setting at or near the statistical distance measurement. However, in an offshore operational mode, any target, whether land or otherwise, may be considered for scaling purposes.

Example embodiments of automatic radar range control described herein may be implemented for the benefit of a variety of different applications. For example, according to some example embodiments, such automatic radar range control may be implemented for radar data display purposes. According to some example embodiments, automatic radar range control may be implemented in the context of autopilot and unmanned drone applications. According to some example embodiments, the automatic radar range control may be coupled with a threshold distance shoreline warning or alert indicating proximity to the shoreline or land. According to some example embodiments, the determined radar range setting may be considered in view of visible targets captured by a video sensor or camera to detect, for example, interference from fog or rain that may be filtered from the land distance data array.

According to some example embodiments, the automatic range control approaches described herein may be applicable beyond radar applications. Such approaches may be implemented in other contexts such as lidar systems that, for example, may be aimed downward from an aircraft.

According to some example embodiments, poor tuning or weather conditions can affect the radar ray returns, resulting in hits that are not useful. In some operational scenarios, the radar signal may not reach a landmass due to improper tuning or weather conditions. In some instances, a radar ray or signal may be saturated beyond a certain range resulting in incorrect distance data. If such a situation arises, the radar controller may be configured to employ a cumulative return threshold method for a given ray. In this regard, the cumulative radar returns along a radar ray may be counted. If the counted returns reaches a count threshold, then the distance at which the threshold is reached can be used a proxy for the distance and other information for a land hit in the data array. Such an approach may permit autoranging even when map data and machine learning models are unavailable.

According to some example embodiments, predictive autoranging may also be performed in accordance with some example embodiments. In this regard, the radar controller may be configured to compute the radar rays relative to a predicted future location of the vessel 150 based on the velocity, acceleration, direction of movement, and the like of the vessel 150, rather than considering only a current location of the vessel 150.

For example, if the vessel 150 is moving north at 10 meters per second and the radar controller is configured with a 60-second lookahead, the predictive radar range value may be computed centered on a point 600 meters north of the current location. Such a lookahead positioning parameter may be configured as a fixed amount of time. Alternatively, the lookahead parameter may be configured as a fixed distance. In other example embodiments, the lookahead parameter may be configured as a distance that is a fraction of the current radar range. Moreover, some example embodiments may also consider vessel speed as a factor when determining the radar range setting, since targets may need to spend sufficient time within the radar range for effective identification. Effective target identification may not be possible when vessel speed or relative target speed is large compared to the active radar range. Accordingly, the distance-to-land radar range prediction may be overridden under certain speed conditions for the vessel.

The automatic radar range control process may be overridden if the vessel is moving at more than a threshold speed or relative speed. According to some example embodiments, the automatic radar range control process may be overridden if the vessel is moving at a speed that exceeds a predetermined percentage of radar range per radar sweep (e.g., 360 degree sweep). For example, if vessel speed causes movement of 10% of radar range per revolution and the target threshold is set to a maximum of 5% movement per revolution, the active radar range should be doubled in this scenario. A stationary or slowly moving vessel may not require such a speed-based correction. Such vessels may operate directly using a distance-to-land automatic radar range control method. The speed-based ranging may function, according to some example embodiments, as a lower limit on radar range values considered during automatic adjustment.

According to some example embodiments, a factor that may be considered in an automatic radar range control process may be a position of a target of interest. In this regard, if a target of interest is known to be nearby, according to some example embodiments, the automatic radar range control process may operate in a manner that ensures that the target of interest remains within the radar range and, preferably, within a reliable radar range. In other words, the automatic radar range control process may operate in a manner that does not place the target of interest out of range due to an adjustment to the radar range setting. A distance to a target of interest or a proximity of the target of interest may be determined in a number of ways, including, but not limited to, radar tracking. Additionally or alternatively, AIS (Automatic Identification System) data for a target of interest may be used for determining distance or proximity information.

In this regard, highly reliable radar detections may occur when a target of interest is neither too close to the vessel nor too near the edge of the radar detection range. Targets that are too close to the vessel may be obscured by sea clutter or distortion. Targets too near the edge of detection range may be distorted or merged with other targets. As such, some example embodiments may restrict the amount of automatic radar range adjustment based on the positions of one or more targets of interest. A lower limit may be established at a first scaling factor multiplied by the distance to the target of interest. In one example embodiment, the first scaling factor may be selected to be 1.2 for the lower limit. An upper limit may be established at a second scaling factor multiplied by the distance to the target of interest. In one example embodiment, the second scaling factor may be 4.0 for the upper limit. These limits may constrain the automatic ranging operations by setting a lower and upper range relative to the distance to the target of interest.

Additionally, according to some example embodiments, an automatic radar range control process may include an automatic tuning feature based on prior parameters used with a radar range setting. In this regard, according to some example embodiments, after the radar range setting may be paired with parameter values for, for example, gain, sea clutter, rain clutter, target expansion, rotation rate, transmit power, or the like. If the radar range setting may be stored with the parameter values for use with the radar range setting in the future. The parameter values may be stored in a data structure associated with the radar range setting, such as, for example, a lookup table. is adjusted based on the scaled statistical distance measurement, the radar controller may adjust the radar range setting and then save that setting in a lookup table or similar data structure to be referred to when making future adjustments to the radar range setting.

According to some example embodiments, an electronic compass calibration process may be implemented. Although the electronic compass calibration process may be perform with an automatic radar range control process, according to some example embodiments, the electronic compass calibration process may be a stand alone process that is used specifically for electronic compass calibration. Thus, according to some example embodiments, the radar controller is further configured to calibrate an electronic compass based on an alignment offset that is determined by the radar controller. The alignment offset may be determined based on a comparison of the shoreline data to at least a portion of the land distance data array.

In this regard, when both map data and radar data, in the form of, for example, radar detections or hits of land, are available, example embodiments may estimate an alignment error between the radar data and the map data. An alignment which maximizes the overlap of the shoreline data from the map data and radar data can provide a useful measure of radar orientation. Using the alignment or misalignment of the radar data to the map data as a truth, an electronic compass can be calibrated accordingly. In other words, the alignment of the map data and radar data (e.g., from the land distance data array) can be used to determine the compass bias (i.e., the difference between the compass measurement of true north and the actual orientation of the radar device). When map data and radar data are of sufficient quality, such a technique may be used to provide measurements that are more accurate than conventional marine electronic compasses. According to some example embodiments, the calibration via alignment as described above may be used as a one time operation for calibrating the compass or the process may be performed by averaging to determine a single “turn on” bias which is applied once. Further, the calibration process may be implemented repeatedly, according to some example embodiments, and applied with a more than one radar frame. Accordingly, the bias estimate (or low pass filtering of the bias estimate) may be applied in real time as the radar images are captured to perform a near-real time correction.

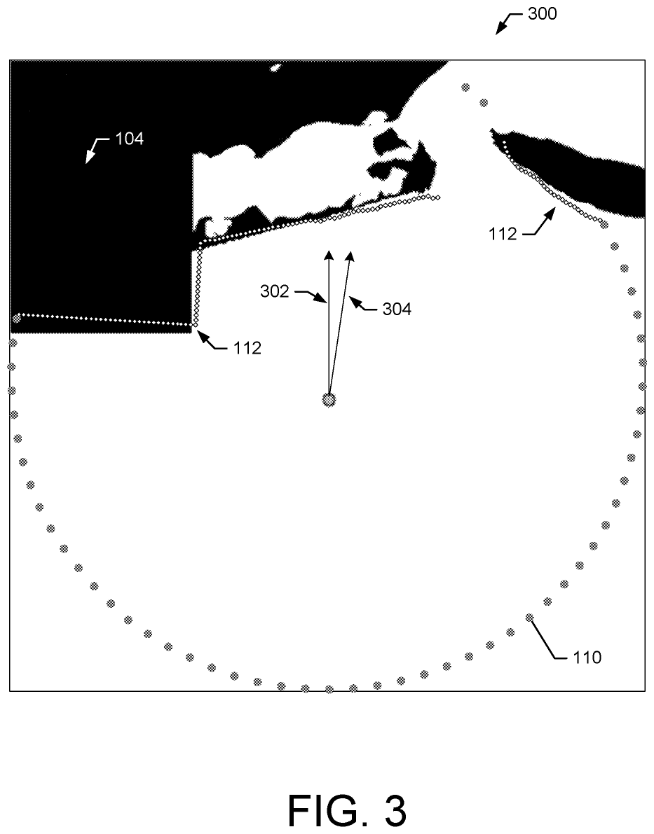

The rendering 300 of FIG. 3 illustrates a misalignment condition that may be used to align the radar data and calibrate a compass. As shown, the land hits 112 are not aligned with the shoreline data of the map. However, the angle of misalignment can be calculated between associated points on the map with land hits 112. As such, an alignment compensation angle may be defined between a direction for the map data (e.g., map data north 302) and a direction for the radar data (e.g., radar data north 304). The angle between map data north 302 and the radar data north 304 may be calculated to determine a true north direction. This true north direction may then be used for calibrating an electronic compass by aligning the compass north with the determined true north.

According to some example embodiments, a system 400 and its components may be implemented by various means. Means for implementing the system and its components may include hardware, alone or under direction of one or more computer programs from a computer-readable storage medium. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

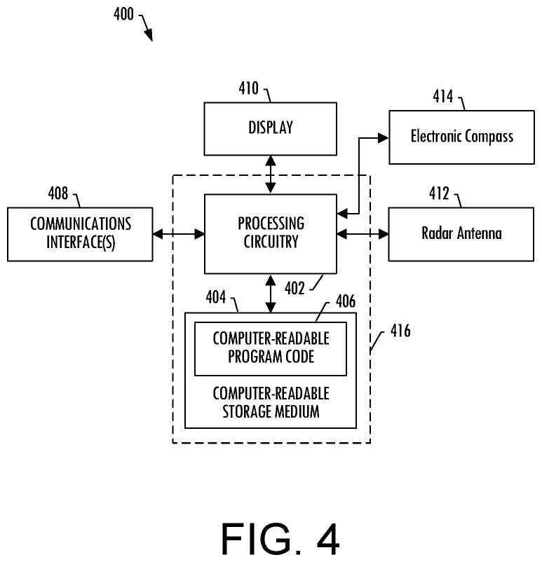

FIG. 4 illustrates a radar system 400, according to some example embodiments. Generally, a system or apparatus according to some example embodiments may comprise, include or be embodied in one or more fixed or portable electronic devices. Examples of suitable electronic devices include a computer that is stand-alone or incorporated into other application devices (e.g., a multi-function display) or the like. The system 400 may include one or more of each of a number of components such as, for example, processing circuitry 402 connected to computer-readable storage medium 404.

The processing circuitry 402 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 404 (of the same or another apparatus).

The processing circuitry 402 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 404 is generally any piece of computer hardware that is capable of storing information such as, for example, data, computer programs (e.g., computer-readable program code 406) and/or other suitable information either on a temporary basis and/or a permanent basis. The computer-readable storage medium may include volatile and/or non-volatile memory, and may be fixed or removable. Examples of suitable memory include random access memory (RAM), read-only memory (ROM), a hard drive, a flash memory, a removable memory, or some combination of the above. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

According to some example embodiments, the system 400 may include a radar controller 416. The radar controller 416 may be embodied in a number of ways. According to some example embodiments, the radar controller 416 may comprise the processing circuitry 402 and the computer-readable storage medium 404.

In addition to the computer-readable storage medium 404, the processing circuitry 402 may also be connected to one or more interfaces for displaying, transmitting and/or receiving information. The interfaces may include a communications interface 408 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links.

The user interfaces may include a display 410 and/or one or more user input interfaces. The display 410 may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

The system 400 may include a radar antenna 412. The radar antenna 412 may include an antenna element and other components that support the operation of the antenna element. In this regard, the radar antenna 412 may include a sweeping motor that rotates the antenna element at a controllable rate to perform radar sweeps. The radar antenna 412 may also include circuitry for filtering and modulating/demodulating signals for transmission/reception via the antenna element.

According to some example embodiments, the system 400 may also include an electronic compass 414. The electronic compass 414 may be configured to detect ordinal directions, such as north based on the earth's magnetic field. The electronic compass may be utilized for map orientation and autonomous maneuvering.

As indicated above, program code instructions may be stored in a computer-readable storage medium, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus, such as the radar controller 416, may include a processing circuitry 402 and a computer-readable storage medium 404 coupled to the processing circuitry, where the processing circuitry is configured to execute computer-readable program code 406 stored in the computer-readable storage medium. It will also be understood that one or more functions, and combinations of functions, may be implemented by special purpose hardware-based computer systems and/or processing circuitry which perform the specified functions, or combinations of special purpose hardware and program code instructions.

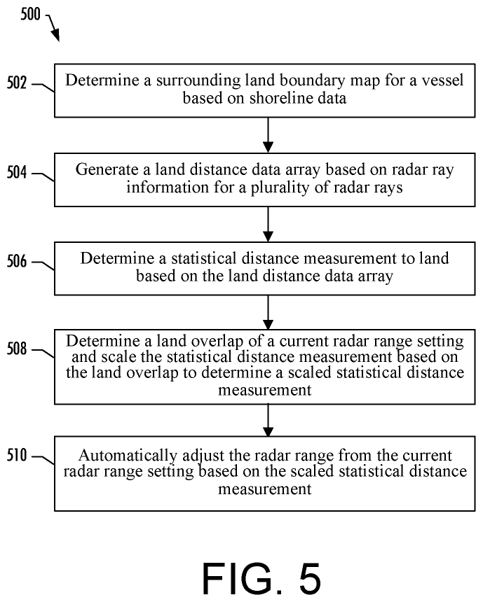

According to some example embodiments, a method for automatic radar range control is now described in association with the flowchart 500 of FIG. 5. The method of FIG. 5 may be implemented, according to some example embodiments, by the system 400 or the radar controller 416.

According to some example embodiments, the example method may comprise, at 502, determining a surrounding land boundary map for a vessel based on shoreline data, and, at 504, generating a land distance data array based on radar ray information for a plurality of radar rays. The plurality of radar rays may be provided by the radar antenna under the control of the radar controller. The radar ray information may comprise, for each radar ray in a plurality of radar rays, an angle the ray from the vessel, a range of the ray to a first land hit, and first land hit coordinate information. The example method may also comprise, at 506, determining a statistical distance measurement to land based on the land distance data array, and, at 508, determining a land overlap of a current radar range setting and scale the statistical distance measurement based on the land overlap to determine a scaled statistical distance measurement. At 510, the example method may also include automatically adjusting the radar range from the current radar range setting based on the scaled statistical distance measurement.

According to some example embodiments, generating the surrounding land boundary map by combining received shoreline vector data with a global positioning system (GPS) location information of the vessel to form a raster image representation as the shoreline data. Additionally or alternatively, the example method may comprise calibrating an electronic compass based on an alignment offset. The alignment offset may be determined based on a comparison of the shoreline data to at least a portion of the land distance data array. Additionally or alternatively, according to some example embodiments, the surrounding land boundary map may be generated based on threshold contour sizes for land detection, implementation of a machine learning model for land detection, or implementation of a machine vision model for land detection. Additionally or alternatively, according to some example embodiments, the example method may include automatically adjusting the radar range setting within a maximum radar range that is based on a line of sight distance to a horizon for the radar antenna and a minimum radar range that is based on a velocity of the vessel and a radar sweep speed. Additionally or alternatively, according to some example embodiments, the example method may comprise determining a maximum radar range based on a line of sight distance to a horizon for the radar antenna and setting the current radar range to the maximum radar range prior to determining the land distance array. Additionally or alternatively, the example method may comprise scaling the statistical distance measurement to exceed a minimum land overlap threshold. Additionally or alternatively, the example method may comprise iteratively resetting the current radar range based on subsequently determined updates to the scaled statistical distance measurement.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A radar system comprising:
a radar antenna; and
a radar controller configured to:
determine a surrounding land boundary map for a vessel based on shoreline data;
generate a land distance data array based on radar ray information for a plurality of radar rays provided by the radar antenna under the control of the radar controller, wherein the radar ray information comprises, for each radar ray in a plurality of radar rays, an angle the ray from the vessel, a range of the ray to a first land hit, and first land hit coordinate information;
determine a statistical distance measurement to land based on the land distance data array;
determine a land overlap of a current radar range setting and scale the statistical distance measurement based on the land overlap to determine a scaled statistical distance measurement; and
automatically adjust a radar range setting from the current radar range setting based on the scaled statistical distance measurement.

2. The radar system of claim 1, wherein the radar controller is configured to generate the surrounding land boundary map by combining received shoreline vector data with a global positioning system (GPS) location information of the vessel to form a raster image representation as the shoreline data.

3. The radar system of claim 1 further comprising an electronic compass; and
wherein the radar controller is further configured to calibrate the electronic compass based on an alignment offset, the alignment offset being determined based on a comparison of the shoreline data to at least a portion of the land distance data array.

4. The radar system of claim 1, wherein the radar controller is configured to generate the surrounding land boundary map based on threshold contour sizes for land detection, implementation of a machine learning model for land detection, or implementation of a machine vision model for land detection.

5. The radar system of claim 1, wherein the radar controller is further configured to automatically adjust the radar range setting to be within a maximum radar range that is based on a line of sight distance to a horizon for the radar antenna and a minimum radar range that is based on a velocity of the vessel and a radar sweep speed.

6. The radar system of claim 1, wherein the radar controller is further configured to determine a maximum radar range based on a line of sight distance to a horizon for the radar antenna and set the current radar range to the maximum radar range prior to determining the land distance array.

7. The radar system of claim 1, wherein the radar controller is configured to scale the statistical distance measurement to exceed a minimum land overlap threshold.

8. The radar system of claim 1, wherein the radar controller is further configured to iteratively reset the radar range setting based on subsequently determined updates to the scaled statistical distance measurement.

9. A radar controller comprising:
a processor; and
a memory storing instructions that, when executed by the processor, configure the radar controller to:
determine a surrounding land boundary map for a vessel based on shoreline data;
generate a land distance data array based on radar ray information for a plurality of radar rays provided by the radar antenna under the control of the radar controller, wherein the radar ray information comprises, for each radar ray in a plurality of radar rays, an angle the ray from the vessel, a range of the ray to a first land hit, and first land hit coordinate information;
determine a statistical distance measurement to land based on the land distance data array;
determine a land overlap of a current radar range setting and scale the statistical distance measurement based on the land overlap to determine a scaled statistical distance measurement;
automatically adjust a radar range setting from the current radar range setting based on the scaled statistical distance measurement.

10. The radar controller of claim 9, wherein the radar controller is configured to generate the surrounding land boundary map by combining received shoreline vector data with a global positioning system (GPS) location information of the vessel to form a raster image representation as the shoreline data.

11. The radar controller of claim 9, wherein the radar controller is further configured to calibrate an electronic compass based on an alignment offset, the alignment offset being determined based on a comparison of the shoreline data to at least a portion of the land distance data array.

12. The radar controller of claim 9, wherein the radar controller is configured to generate the surrounding land boundary map based on threshold contour sizes for land detection, implementation of a machine learning model for land detection, or implementation of a machine vision model for land detection.

13. The radar controller of claim 9, wherein the radar controller is further configured to automatically adjust the radar range setting to be within a maximum radar range that is based on a line of sight distance to a horizon for the radar antenna and a minimum radar range that is based on a velocity of the vessel and a radar sweep speed.

14. The radar controller of claim 9, wherein the radar controller is further configured to determine a maximum radar range based on a line of sight distance to a horizon for the radar antenna and set the current radar range to the maximum radar range prior to determining the land distance array.

15. The radar controller of claim 9, wherein the radar controller is configured to scale the statistical distance measurement to exceed a minimum land overlap threshold.

16. The radar controller of claim 9, wherein the radar controller is further configured to iteratively reset the radar range setting based on subsequently determined updates to the scaled statistical distance measurement.

17. A method for automatically setting a range for a radar system comprising:
determining a surrounding land boundary map for a vessel based on shoreline data;
generating, by a radar controller, a land distance data array based on radar ray information for a plurality of radar rays provided by the radar antenna under the control of the radar controller, wherein the radar ray information comprises, for each radar ray in a plurality of radar rays, an angle the ray from the vessel, a range of the ray to a first land hit, and first land hit coordinate information;
determining a statistical distance measurement to land based on the land distance data array;
determining a land overlap of a current radar range setting and scale the statistical distance measurement based on the land overlap to determine a scaled statistical distance measurement;
automatically adjusting a radar range setting from the current radar range setting based on the scaled statistical distance measurement.

18. The method of claim 17 further comprising generating the surrounding land boundary map by combining received shoreline vector data with a global positioning system (GPS) location information of the vessel to form a raster image representation as the shoreline data.

19. The method of claim 17 further comprising calibrating an electronic compass based on an alignment offset, the alignment offset being determined based on a comparison of the shoreline data to at least a portion of the land distance data array.

20. The method of claim 17 further comprising automatically setting the radar range within a maximum radar range that is based on a line of sight distance to a horizon for the radar antenna and a minimum radar range that is based on a velocity of the vessel and a radar sweep speed.
